(19) United States
(12) Patent Application Publication
(10) Pub. No.: US 2013/0166270 A1
(43) Pub. Date: Jun. 27, 2013

(54) METHOD OF SUBSTATION-CONTROL CENTER TWO-LEVEL DISTRIBUTED MODELING FOR POWER GRID

(71) Applicants: Hongbin Sun, Beijing (CN); Minhui Ge, Shanghai (CN); Wenchuan Wu, Beijing (CN); Dexing Wang, Shanghai (CN); Qinglai Guo, Beijing (CN); Boming Zhang, Beijing (CN); Jing Wang, Beijing (CN)

(72) Inventors: Hongbin Sun, Beijing (CN); Minhui Ge, Shanghai (CN); Wenchuan Wu, Beijing (CN); Dexing Wang, Shanghai (CN); Qinglai Guo, Beijing (CN); Boming Zhang, Beijing (CN); Jing Wang, Beijing (CN)

(73) Assignees: EAST CHINA GRID COMPANY LIMITED, Shanghai (CN); Tsinghua University, Beijing (CN)

(21) Appl. No.: 13/367,517

(22) Filed: Feb. 7, 2012

(30) Foreign Application Priority Data
Dec. 23, 2011 (CN) 201110439009.9

(51) Int. Cl. G06F 17/50

(52) U.S. Cl. 703/18

(57) ABSTRACT

A method of substation-control center two-level distributed modeling for power grid is provided. The method comprises: (1) building a substation model for each of substations, each substation model comprising a network model having a topological structure of the substation devices, parameters of the substation devices and measurement information of each substation devices, and a wiring diagram of each substation based on a whole line identification consistency; (2) uploading each substation model for each of the substations to the control center through a state power dispatching data network; and (3) splicing network models for the substations according to the wiring diagrams of the substations to build a whole power grid model of a whole power grid so as to monitor and control the whole power grid.

### CROSS-REFERENCE TO RELATED APPLICATION

This application claims priority to and benefits of Chinese Patent Application Serial No. 201110439009.9, filed with the State Intellectual Property Office of P. R. China on Dec. 23, 2011, the entire content of which is incorporated herein by reference.

### FIELD

The present disclosure belongs to power system operation and control field, and more particularly to a method of substation-control center two-level distributed modeling for power grid control center.

### BACKGROUND

An energy management system (EMS) is a dispatching automation system of a modern power system based on a computer. The task of the EMS is to collect, monitor, analyze, optimize, and control a power system. A grid model and a wiring diagram are the base and the key part of the EMS and are the base of monitoring, analyzing, optimizing and controlling the power system. The grid model comprises a topological structure of devices, parameters of the devices and measurement information. The topological structure of the devices and the parameters of the devices comprise topological structures and parameters of a device such as a transformer, a line, a generator, a load, a switch, an isolation switch or a grounding switch. The measurement information comprises analogue measurement information and digital measurement information such as a measurement object and measure value object associated therewith as well as a measurement type object. Alternatively, the grid model comprises a substation model and a line model. Each substation model is a model consisting of topological structures, parameters and measurement information of a device such as a generator, a load, a switch, an isolation switch or a grounding switch in each substation, and the line model is a model formed by connecting all the lines in each station. Each line has two terminals which are connected to two substations connected by the each line. The wiring diagram comprises graphics and dynamic data of a device. For example, the graphics of the device is graphics of a transformer, a line, a generator, a load, a switch, an isolation switch, a grounding switch, etc.

In a conventional energy management system, all modeling for the devices are finished based on an IEC61970, the model is a single-phase model, the wiring diagram is a single-line drawing, and the grid model is not maintained at the stations and the substations. The stations and the substations are communicated with intelligent electronic devices (IED) based on an IEC61850 standard to obtain measurement data (real-time values of analogue information and digital information) of devices in the stations and the substations, and a part of the measurement data are uploaded to the control center based on an IEC61870 standard through a remote terminal unit.

Main problems existing in this centralized method are as follows. (1) The building of a whole power grid model comprising the parameters, static topologies and one-time wiring diagrams of the devices needs to be completed at the control center, so work load may increase significantly with the increasing of the grid scale. (2) Because maintainers in the control center may not be very familiar with each detail of the grid, probability of potential errors may be very large, and parameter errors and topological errors will be buried in huge information of the grid model and are difficult to position. (3) In the current modeling method, if the control center is suffered from a disaster, entire functions of the control center may be paralyzed and difficult to self-cure.

### SUMMARY

The present disclosure is directed to solve at least one of the problems existing in the prior art. Accordingly, a method of substation-control center two-level distributed modeling for power grid is provided, by which one-time modeling and whole power grid utilization may be achieved, so that the hierarchic processing of information and the self-curing of the control center may be possible.

According to an embodiment of the present disclosure, a method of substation-control center two-level distributed modeling for power grid is provided. The method comprises: (1) building a substation model locally for each of substations, the substation model comprising a network model having a topological structure, parameters and measurement information of the substation devices, and a wiring diagram of each substation based on a whole line identification consistency; (2) uploading each substation model to the control center through a state power dispatching data network; and (3) splicing network models for the substations and the wiring diagrams of the substations to build a whole power grid model of a whole power grid so as to monitor and control the whole power grid.

Compared with a conventional centralized power grid modeling method in a control center, with a method of substation-control center two-level distributed modeling for power grid according to an embodiment of the present disclosure, because a modeling scale in each substation is small, it is usually required that modeling is only performed once when each substation is newly built or rebuilt, that is, the modeling no longer changes. For a substation in which a power grid model is false, the grid model may be conveniently diagnosed and positioned at the substation. In addition, graphics, models or databases in the substations may not need to be maintained at the control center, thus simplifying the maintenance of the control center, decreasing error probability, and greatly reducing work load and error rate of the maintenance. In an ideal case, no maintenance may be even required. Furthermore, with a method of substation-control center two-level distributed modeling for power grid according to an embodiment of the present disclosure, because distributed modeling is achieved and models are distributed in power stations and substations, after the control center is paralyzed due to a disaster, models in the power stations and the substations may not be lost, and the function of the control center may be quickly recovered at any point of the state power dispatching data network by automatic splicing of the models distributed in the power stations and the substations, so that the disaster tolerance and the self-curing of the control center may be possible.

In one embodiment, the network model comprises a three-phase topological structure, three-phase parameters, and three-phase measurement information of the substation devices, and the wiring diagram of each substation comprises graphics and three-phase dynamic data of the substation devices. Therefore, situations such as unbalanced operation in the power grid may be reflected by modeling in a substation distributed modeling using a three-phase model.

In one embodiment, the step (1) comprises: obtaining real-time measurement data of each substation according to an IEC61850 standard to monitor each substation in real time so as to monitor each substation according to the network model for each substation as well as the wiring diagram and the real-time measurement data of each substation.

In one embodiment, the step (1) comprises: clipping the network model for each substation to be adapted to the control center and clipping the wiring diagram of each substation to be adapted to the control center.

In one embodiment, clipping the network model for each substation to be adapted to the control center comprises: (a) converting the three-phase topological structure and the three-phase parameters of the substation devices into a single-phase positive-sequence topological structure and single-phase positive-sequence parameters of the substation devices respectively; (b) replacing station load transformer and house load transformer with low voltage level by equivalent loads in the network model for each substation; (c) converting analogue measurement information in the three-phase measurement information into positive-sequence analogue measurement information and removing analogue measurement information of a breaker in the positive-sequence analogue measurement information; and (d) converting digital measurement information in the three-phase measurement information into total digital measurement information.

In one embodiment, clipping the wiring diagram of each substation to be adapted to the control center comprises: removing graphics of a grounding switch in the wiring diagram; replacing graphics of the station load transformer and the house load transformer in each substation with low voltage level by graphics of the equivalent loads; and converting the three-phase dynamic data in the wiring diagram into single-phase dynamic data.

In one embodiment, the step (1) further comprises: exporting the clipped network model for each substation.

In one embodiment, exporting the clipped model for each substation comprises: exporting the clipped network model for each substation as a network model XML file accorded with a common information model, and expanding a portion of classes in the network model XML file; and exporting the clipped wiring diagram of each substation as a wiring diagram XML file accorded with scalable vector graphics.

In one embodiment, adding address attributes for a substation class in the network model XML file; and adding the address attributes for a measure value class in the network model XML file.

In one embodiment, before the step (2), the method further comprises: judging the exported network model for each substation and the exported wiring diagram of each substation; and executing the step (2) if the network model for each substation and the wiring diagram of each substation are different from a previous network model for each substation and a previous wiring diagram of each substation or the network model for each substation or the wiring diagram of each substation is not uploaded, otherwise, returning to the step (1) after a first predetermined time (T₁).

In one embodiment, before the step (3), the method further comprises: checking the network model for each substation and the wiring diagram of each substation.

In one embodiment, parsing the network model XML file to check whether the network model XML file accords with a format of the common information model file, and to check whether the topological structure of each substation, and sending error information to a corresponding substation through the state power dispatching data network and returning to the step (1) if either checking is not successful; parsing the wiring diagram XML file to check whether the wiring diagram XML file accords with a format of scalable vector graphics and to check whether mappings of the scalable vector graphics and the common information model match each other, and sending error information to a corresponding substation through the state power dispatching data network and returning to the step (1) if either checking is not successful; and executing the step (3) if all of the checking are successful.

In one embodiment, the step (3) comprises: 3-1) importing a network model for one substation to build a substation model having a hierarchical structure and a line model list; 3-2) importing a network model for a next substation to build a substation model and a line model list of the next substation, and adding the substation model of the next substation to the built substation model of the one substation; 3-3) determining whether the line model of the next substation exists in the built line model of the one substation, deleting the line model of the next substation line model list and associating terminals and measurement information associated with the line model of the next substation with the built line model of the one substation line model list if the line model of the next substation exists in the built line model of the one substation, and directly adding the line model of the next substation model list as well as terminals and measurement information associated therewith to the built line model of the one substation model list if the line model of the next substation does not exist in the built line model of the one substation; 3-4) traversing all the line models of the next substation line model list to finish the splicing of the network model for the next substation; and 3-5) repeating the step 3-2) to the step 3-4) until all substations are traversed so as to build the whole power grid model according to a final substation model and a final line model.

In one embodiment, each substation model has a hierarchical structure of a substation-voltage level-device.

In one embodiment, after the step (3), the method further comprises: collecting real-time measurement data through the control center to obtain measurement information.

In one embodiment, the control center obtains messages of station addresses, information object addresses and real-time data values through an IEC61850-104 protocol, and the real-time data values are values of a measure value object when information object addresses of the measure value object and station addresses of a substation comprising the measure value object in the measurement information are accorded with those in the messages respectively.

In one embodiment, the method further comprises: determining whether a network model for the control center is false, sending a command of calling the substation model for each substation and the wiring diagram of each substation and returning to the step (2) if the network model for the control center is false, and determining whether the network model for the control center is false again after a second predetermined time (T₂) if the network model for the control center is not false; and sending a command of calling the substation model for each substation and the wiring diagram of each substation through other servers in the state power dispatching data network and returning to the step (2) if the control center is paralyzed.

In one embodiment, it is determined that the network model for the control center is false when a topological structure of the control center is false, state estimation computing based on the network model for the control center is not convergent, and a database of the control center is false.

Additional aspects and advantages of the embodiments of the present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of the disclosure will become apparent and more readily appreciated from the following descriptions taken in conjunction with the drawings in which:

FIG. 1 is a schematic diagram of a method of substation-control center two-level distributed modeling for power grid according to an embodiment of the present disclosure;

FIG. 2 is a flow chart of a method of substation-control center two-level distributed modeling for power grid according to an embodiment of the present disclosure;

FIG. 3 is a flow chart of a splicing step in a method of substation-control center two-level distributed modeling for power grid according to an embodiment of the present disclosure;

FIG. 4 is a schematic diagram of a method of substation-control center two-level distributed modeling for power grid which schematically shows two substation models according to an embodiment of the present disclosure;

FIG. 5 is a schematic diagram of a method of substation-control center two-level distributed modeling for power grid after two substation models are clipped according to an embodiment of the present disclosure;

FIG. 6 is a schematic diagram of a method of substation-control center two-level distributed modeling for power grid after two substation models are spliced to build a whole power grid model of a whole power grid according to an embodiment of the present disclosure.

### DETAILED DESCRIPTION

Embodiments of the present disclosure will be described in detail in the following descriptions, examples of which are shown in the accompanying drawings, in which the same or similar elements and elements having same or similar functions are denoted by like reference numerals throughout the descriptions. The embodiments described herein with reference to the accompanying drawings are explanatory and illustrative, which are used to generally understand the present disclosure. The embodiments shall not be construed to limit the present disclosure.

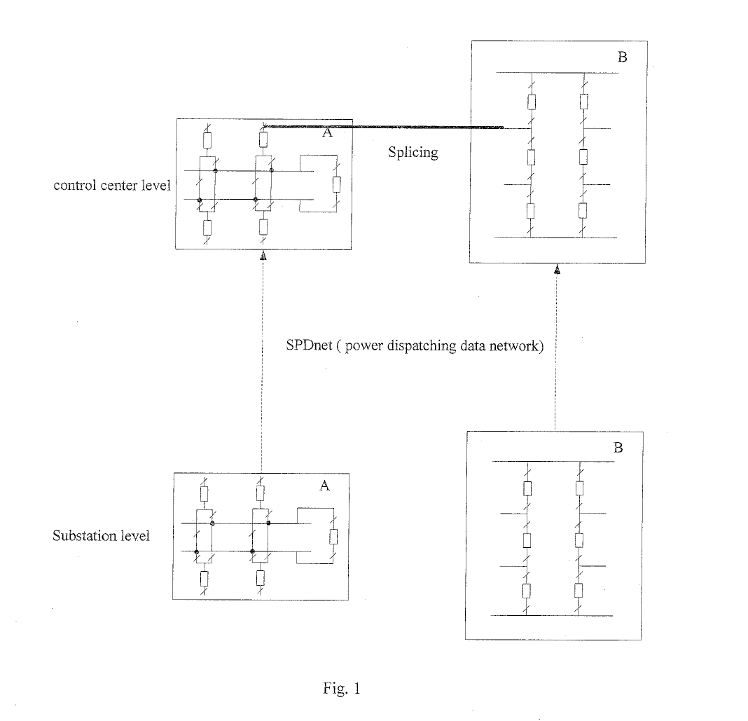

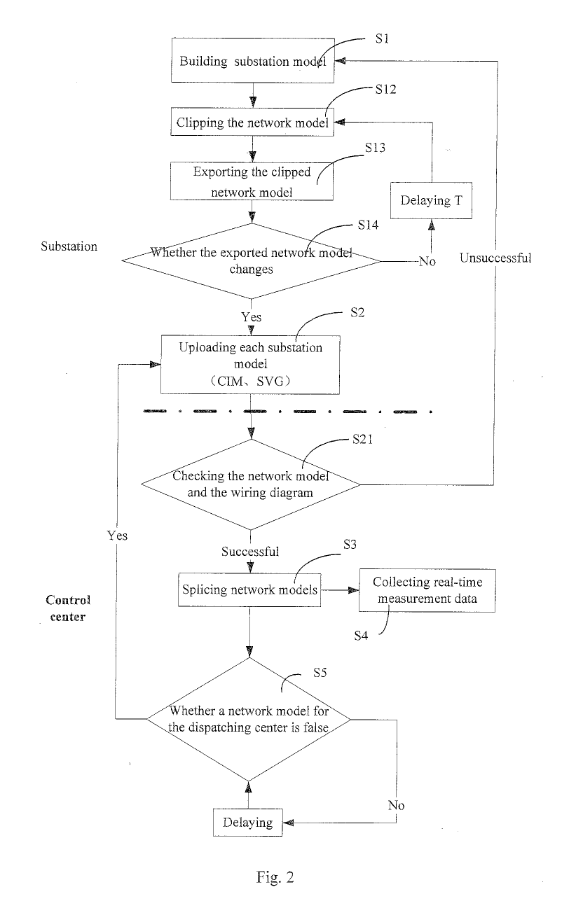

A method of substation-control center two-level distributed modeling for power grid will be described below in detail with reference to the drawings. FIG. 1 is a schematic diagram of a method of substation-control center two-level distributed modeling for power grid according to an embodiment of the present disclosure. FIG. 2 is a flow chart of a method of substation-control center two-level distributed modeling for power grid according to an embodiment of the present disclosure.

As shown in FIG. 2, the method comprises: (1) building a substation model locally for each of substations, the substation model comprising a network model having a topological structure, parameters and measurement information of the substation devices, and a wiring diagram of each substation based on a whole line identification consistency; (2) uploading each substation model to the control center through a state power dispatching data network; and (3) splicing network models for the substations according to the wiring diagrams of the substations to build a whole power grid model of a whole power grid so as to monitor and control the whole power grid. Because the wiring diagram of each substation is based on the whole line identification consistency, the network models for the substations may be conveniently spliced based on the whole line identification consistency.

Compared with a conventional centralized grid modeling method in a control center, with the method of substation-control center two-level distributed modeling for power grid according to an embodiment of the present disclosure, because a modeling scale in each substation is small, it is usually required that modeling is only performed once when each substation is newly built or rebuilt, that is, the modeling no longer changes. For a substation in which a grid model is false, the grid model may be conveniently diagnosed and positioned at the substation. In addition, graphics, models or databases in the substations may not need to be maintained at the control center, thus simplifying the maintenance of the control center, decreasing error probability, and greatly reducing work load and error rate of the maintenance. In an ideal case, no maintenance may be even achieved. Furthermore, with the method of substation-control center two-level distributed modeling for power grid according to an embodiment of the present disclosure, because distributed modeling is achieved and models are distributed in power stations and substations, after the control center is paralyzed due to a disaster, models in the power stations and the substations may not lose, and the function of the control center may be quickly recovered at any point of the state power dispatching data network by automatic splicing of the models distributed in the power stations and the substations, so that the disaster tolerance and the self-curing of the control center may be possible.

In one embodiment, the network model may comprise a topological structure, parameters and measurement information of the substation devices of the substations, and the wiring diagram comprises graphics and dynamic data of the substation devices. Alternatively, the network model comprises a three-phase topological structure of the substation devices, three-phase parameters of the substation devices, and three-phase measurement information of the substation devices, and the wiring diagram of each substation comprises graphics and three-phase dynamic data of the substation devices. Therefore, situations such as unbalanced operation in the power grid may be reflected by modeling in a substation distributed modeling using a three-phase model. The step S1 may comprise: obtaining real-time measurement data of each substation according to an IEC61850 standard to monitor each substation in real time so as to monitor each substation according to the network model for each substation as well as the wiring diagram and the real-time measurement data of each substation.

In one embodiment, the step S1 comprises: clipping the network model for each substation to be adapted to the control center and clipping the wiring diagram of each substation to be adapted to the control center (step S12). Further, clipping the network model for each substation to be adapted to the control center comprises: (a) converting the three-phase topological structure and the three-phase parameters of the substation devices into a single-phase positive-sequence topological structure and single-phase positive-sequence parameters of the substation devices respectively; (b) replacing station load transformer and house load transformer with low voltage level by equivalent loads in the network model for each substation; (c) converting analogue measurement information in the three-phase measurement information into positive-sequence analogue measurement information and removing analogue measurement information of a breaker in the positive-sequence analogue measurement information; and (d) converting digital measurement information in the three-phase measurement information into total digital measurement information. Clipping the wiring diagram of each substation to be adapted to the control center comprises: removing graphics of a grounding switch in the wiring diagram; replacing graphics of the station load transformer and the house load transformer in each substation with low voltage level by graphics of the equivalent loads; and converting the three-phase dynamic data in the wiring diagram into single-phase dynamic data.

Then, the clipped network model for each substation is exported (step S13). Particularly, the step S13 comprises: exporting the clipped network model for each substation as a network model XML file accorded with a common information model, and expanding a portion of classes in the network model XML file; and exporting the clipped wiring diagram of each substation as a wiring diagram XML file accorded with scalable vector graphics. Specifically, after clipped, the network model for each substation is exported as an XML file accorded with the common information model (CIM), the wiring diagram of each substation is exported as an XML file accorded with scalable vector graphics (SVG), and the CIM is expanded for associating clipped real-time measure data uploaded by an IEC61870-104 protocol. In one embodiment, a portion of classes in the CIM is expanded, that is, address attributes (a station address corresponding to each substation) are added for an original substation class in the CIM, and address attributes (measurement information object addresses corresponding to the real-time data) are added for an original measure value class in the CIM.

As shown in FIG. 2, before the step S2, the exported network model for each substation and the exported wiring diagram of each substation are judged (S14); and the step (S2) is executed if the network model for each substation and the wiring diagram of each substation are different from a previous network model for each substation and a previous wiring diagram of each substation or the network model for each substation or the wiring diagram of each substation is not uploaded, otherwise, the step (S1) is returned to after a first predetermined time (T₁).

As shown in FIG. 2, after the step S2, the network model for each substation and the wiring diagram of each substation are checked (S21). In one embodiment, the step S21 comprises: parsing the network model XML file to check whether the network model XML file accords with a format of the common information model file, and to check whether the topological structure of each substation is reasonable, and sending error information to a corresponding substation through the state power dispatching data network and returning to the step (S1) if either checking is not successful; parsing the wiring diagram XML file to check whether the wiring diagram XML file accords with a format of scalable vector graphics and to check whether mappings of the scalable vector graphics and the common information model match each other, and sending error information to a corresponding substation through the state power dispatching data network and returning to the step (S1) if either checking is not successful; and executing the step (S3) if all of the checking are successful, as shown in FIG. 2. In one embodiment, when it is determined that an ungrounded device is grounded and a node is floated, it is considered that the topological structure is reasonable.

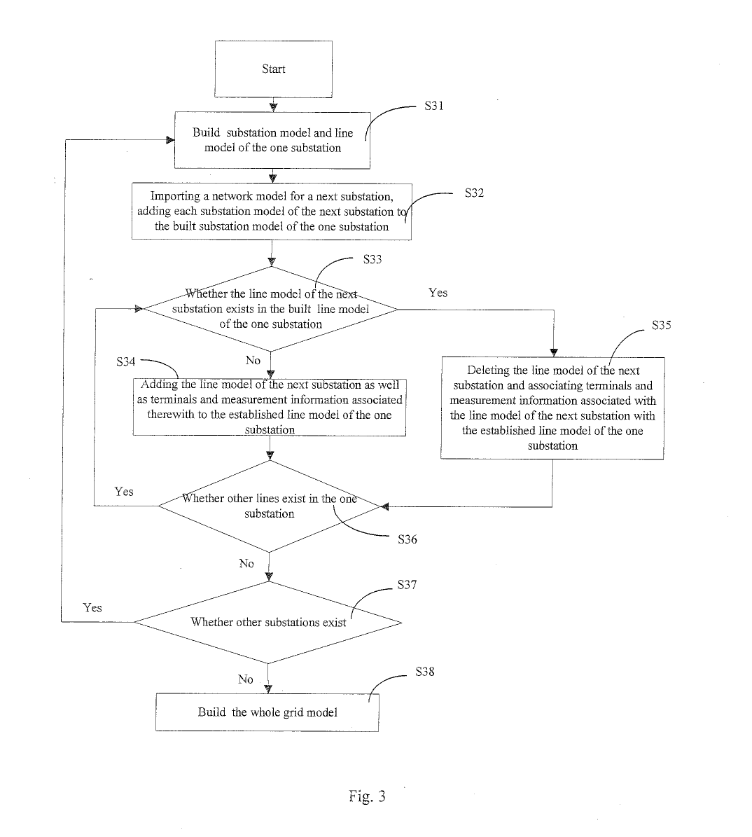

The splicing step (i.e., step S3) in the method of substation-control center two-level distributed modeling for power grid according to an embodiment of the present disclosure will be described below with reference to FIG. 3. In the splicing step, the splicing of the network models for the substations is performed using a line in the wiring diagram as the sole boundary.

In one embodiment, the step (S3) comprises: importing a network model for one substation to build a substation model having a hierarchical structure and a line model list of the one substation (S31); importing a network model for a next substation to build a substation model and a line model of the next substation, and adding the substation model of the next substation to the built substation model of the one substation (S32); determining whether the line model of the next substation exists in the built line model of the one substation (S33), deleting the line model of the next substation line model list and associating terminals and measurement information associated with the line model of the next substation with the built line model of the one substation line model list if the line model of the next substation exists in the built line model of the one substation, (S34), and directly adding the line model of the next substation model list as well as terminals and measurement information associated therewith to the built line model of the one substation model list if the line model of the next substation does not exist in the built line model of the one substation (S35); traversing all the line models of the next substation line model line to finish the splicing of the network model for the next substation (S36); and repeating the step (S32) to the step (S34) until all substations are traversed (S37) so as to build the whole power grid model according to a final substation model and a final line model (S38). In the above steps, each substation model has a hierarchical structure of a substation-voltage level-device.

As shown in FIG. 2, alternatively, the method may further comprise: collecting real-time measurement data through the control center to obtain measurement information (S4).

In one embodiment, the control center obtains messages of station addresses, information object addresses and real-time data values through an IEC61850-104 protocol, and the real-time data values are values of a measure value object when information object addresses of the measure value object and station addresses of a substation comprising the measure value object in the measurement information are accorded with those in the messages respectively.

As shown in FIG. 2, the method may further comprise: determining whether a network model for the control center is false (S5), sending a command of calling the substation model for each substation and the wiring diagram of each substation and returning to the step (2) if the network model for the control center is false, and determining whether the network model for the control center is false again after a second predetermined time (T₂) if the network model for the control center is not false; and sending a command of calling the substation model for each substation and the wiring diagram of each substation through other servers in the state power dispatching data network and returning to the step (2) if the control center is paralyzed. In one embodiment, it is determined that the network model for the control center is false when a topological structure of the control center is false, state estimation computing based on the network model for the control center is not convergent, and a database of the control center is false.

The method of substation-control center two-level distributed modeling for power grid according to an embodiment of the present disclosure will be further described below with reference to FIGS. 4-6. FIG. 4 is a schematic diagram of a method of substation-control center two-level distributed modeling for power grid which schematically shows two substation models A and B according to an embodiment of the present disclosure.

As shown in FIG. 4, a network model and a wiring diagram are built for each substation, in which the network model may comprise a topological structure, parameters and measurement information of the substation devices, and the wiring diagram comprises graphics and dynamic data of the substation devices. The dynamic data of the substation devices are three-phase dynamic data. The topological structure of the substation devices is a three-phase topological structure, the parameters of the substation devices are three-phase parameters, and measurement information of the substation devices is three-phase measurement information. Meanwhile, real-time measurement data of each substation are obtained according to the IEC61850 standard. The network model and graphics and the real-time measurement data of each substation are used for monitoring, analyzing and computing each substation.

As shown in FIG. 4, the substation A and the substation B are connected via a line L1. The modeling situation of each substation is as follows. The substation A comprises a voltage level with a single-bus structure, and the line L1 is connected to a bus 1 via an isolation switch D1 and a circuit breaker B1. The line L1 has a terminal T1 at the substation A side, and the terminal T1 is connected to a terminal T3 of a grounding switch via a connecting node CN1 and connected to a terminal T2 of the isolation switch D1 via the connecting node CN1. Three-phase current measurements (Ia, Ib, Ic) exist in the isolation switch D1, the circuit breaker B1 and the line L1, and three-phase voltage measurements (Ua, Ub, Uc) exist in the bus 1. The three-phase current measurements (Ia, Ib, Ic) and three-phase voltage measurements (Ua, Ub, Uc) are shown by dynamic data in the wiring diagram.

The substation B comprises a voltage level with a double-bus structure, and the line L1 is connected to a bus 1 via an circuit breaker B1, a switch D3 and an isolation switch D1 and connected to a bus 2 via an circuit breaker B1, a switch D3 and an isolation switch D2. The line L1 has a terminal T2 at the substation B side, and the terminal T2 is connected to a terminal T3 of a grounding switch via a connecting node CN1 and connected to a terminal T1 of an isolation switch via the connecting node CN1. Three-phase current measurements (Ia, Ib, Ic) exist in the circuit breaker B1, the isolation switch D2, the switch D3 and the line L1, and three-phase voltage measurements (Ua, Ub, Uc) exist in the bus 1 and the bus 2. The three-phase current measurements (Ia, Ib, Ic) and the three-phase voltage measurements (Ua, Ub, Uc) are shown by dynamic data in the wiring diagram.

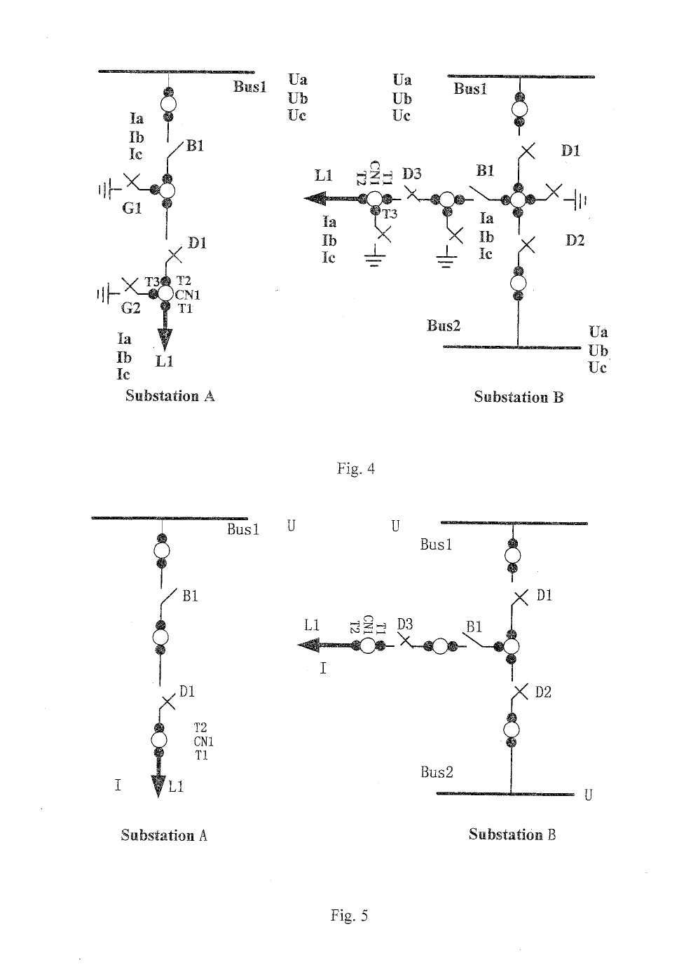

FIG. 5 is a schematic diagram of a method of substation-control center two-level distributed modeling for power grid after two substation models are clipped according to an embodiment of the present disclosure. According to the requirement of the control center, the network model for each substation and the wiring diagram of each substation may be clipped. Alternatively, the clipping of the network model for each substation may comprise: (a) converting the three-phase topological structure and the three-phase parameters of the substation devices into a single-phase positive-sequence topological structure and single-phase positive-sequence parameters of the substation devices respectively; (b) replacing station load transformer and house load transformer with low voltage level by equivalent loads in the network model for each substation; (c) converting analogue measurement information in the three-phase measurement information into positive-sequence analogue measurement information and removing analogue measurement information of a breaker in the positive-sequence analogue measurement information; and (d) converting digital measurement information in the three-phase measurement information into total digital measurement information. The clipping of the wiring diagram of each substation mainly comprises: removing graphics of a grounding switch in the wiring diagram; replacing graphics of the station load transformer and the house load transformer in each substation with low voltage level by graphics of the equivalent loads; and converting the three-phase dynamic data in the wiring diagram into single-phase dynamic data.

The clipped network models for the substation A and the substation B are shown in FIG. 5. The three-phase topological structure and the three-phase parameters of the substation devices are converted into a single-phase positive-sequence topological structure and single-phase positive-sequence parameters of the substation devices respectively. The analogue measurement of a breaker is deleted, the three-phase current measurements (Ia, Ib, Ic) are converted into positive-sequence current measurements (I), and the three-phase voltage measurements (Ua, Ub, Uc) are converted into positive-sequence voltage measurements (U). In FIG. 5, grounding switch graphics G1-G5 are deleted, and the three-phase current dynamic data (Ia, Ib, Ic) and the three-phase voltage dynamic data (Ua, Ub, Uc) are converted into positive-sequence current dynamic data (I) and positive-sequence voltage dynamic data (U) respectively.

Then, the clipped network model for each substation is exported. That is, the clipped network model for each substation is exported as an XML file accord with the common information model (CIM), the clipped wiring diagram of each substation is exported as an XML file accord with scalable vector graphics (SVG), and the CIM is expanded for associating clipped real-time measure data uploaded by an IEC61870-104 protocol. In one embodiment, a portion of classes in the CIM is expanded, as shown in Table 1.

TABLE 1

| | | Type of | Description of |
|---|---|---|---|
| Class | Attribute | Attribute | Attribute |
| Substation | Address | Long | Station Address Corresponding |
| | | | to Each Substation |
| Measure | Address | Long | Measurement Information Object |
| Value | Value | | Addresses Corresponding to The |
| | | | Real-Time Data |

In Table 1, address attributes (a station address corresponding to each substation) are added for an original substation class in the CIM, and address attributes (measurement information object addresses corresponding to the real-time data) are added for an original measure value class in the CIM.

In the network model for the substation A (expansion station address, Address, with a value of 003DH), and expansion information object addresses corresponding to the measure values corresponding to the current measurements associated with the line L1 are 4001H.

Thereafter, the exported network model for each substation and the exported wiring diagram of each substation are judged; and the step S2 is executed if the network model for each substation and the wiring diagram of each substation are different from a previous network model for each substation and a previous wiring diagram of each substation or the network model for each substation or the wiring diagram of each substation is not uploaded, otherwise, the step S1 is returned to after a first predetermined time T₁ (30 min). Then, the exported network model for each substation (CIM file) and the exported wiring diagram of each substation (SVG file) are uploaded to the control center through the state power dispatching data network in the form of files.

Then, the network model for each substation and the wiring diagram of each substation are checked by the control center: parsing the CIM file to check whether a format of the CIM file and the topological structure of each substation are reasonable (that is, whether an ungrounded device is grounded, whether a node is floated, etc.), and sending error information to a corresponding substation through the state power dispatching data network and returning to the step S1 if either checking is not successful; parsing the SVG file of each substation to check whether the SVG file accords with a format of scalable vector graphics and whether mappings of the SVG and the CIM match each other, and sending error information to a corresponding substation through the state power dispatching data network and returning to the step S1 if either checking is not successful; executing the step S3 if all of the checking are successful; and if the line L1 is directly grounded, then determining that the checking is unsuccessful and returning to the step S1 to modeling again.

All the checked network models for the substations are spliced at the control center. In the splicing step, the splicing of the network models for the substations is performed using a line in the wiring drawing as a unique boundary. The splicing flow chart is shown in FIG. 3. The splicing steps are the same as those described above, so a detailed description thereof will be omitted for brevity.

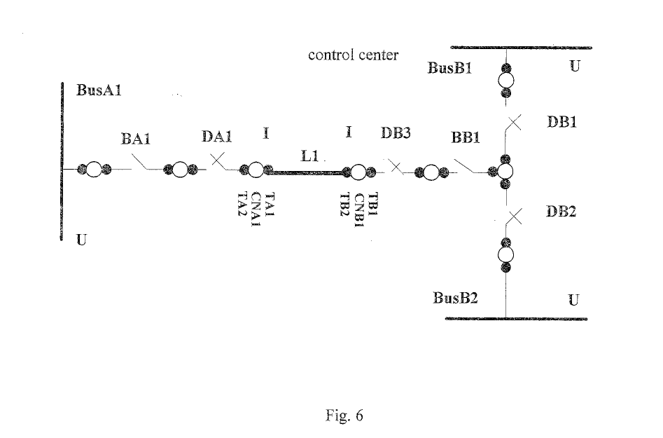

In one example, a corresponding line model L1 in the substation B is deleted, the terminal T2 and measurement information associated with the corresponding line model L1 in the substation B are associated with a corresponding line model L1 in the substation A, and substation names are added in substation device names. The spliced whole power grid model of the whole power grid is shown in FIG. 6.

In addition, as described above, the control center may collect real-time measure data. That is, messages of station addresses, information object addresses and real-time data values are obtained by the control center through an IEC61850-104 protocol, and the real-time data values are values of a measure value object when information object addresses of the measure value object and station addresses of a substation comprising the measure value object in the measurement information are identical with those in the messages respectively.

An IEC61870-104 protocol between the control center and the substation A is built to call the real-time data. A received message is as follows:

68 15 0000 0000 34 01 0300 3D00 014000 0100 000000000000.

It may be seen by analyzing the message that, the message is a normalized measure value having a time mark of a substation with a station address of 003D, in which the information object address is 4001H, and the value is 1. That is, the current measurement of the line L1 at the substation A side is 1.

As shown in FIG. 2, it is determined whether a network model for the control center is false (for example, a topological structure of the control center is false, state estimation computing based on the network model for the control center is not convergent, and a database of the control center is lost), a command of calling the substation model for each substation and the wiring diagram of each substation is sent and the step S2 is returned to if the network model for the control center is false, and it is determined whether the network model for the control center is false again after a second predetermined time T₂ (generally 1 day) if the network model for the control center is not false; and a command of calling the substation model for each substation and the wiring diagram of each substation through other servers in the state power dispatching data network is sent and the step S2 is returned to if the control center is paralyzed.

If state estimation computing based on the network model for the control center is not convergent or the line L1 is directly grounded, the step S2 is returned to.

With the method of substation-control center two-level distributed modeling for power grid according to an embodiment of the present disclosure, one-time modeling and whole power grid utilization may be achieved, so that the staged processing of information and the self-curing of the control center may be possible.

Reference throughout this specification to “an embodiment”, “some embodiments”, “one embodiment”, “an example”, “a specific examples”, or “some examples” means that a particular feature, structure, material, or characteristic described in connection with the embodiment or example is included in at least one embodiment or example of the disclosure. Thus, the appearances of the phrases such as “in some embodiments”, “in one embodiment”, “in an embodiment”, “an example”, “a specific examples”, or “some examples” in various places throughout this specification are not necessarily referring to the same embodiment or example of the disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, and modifications may be made in the embodiments without departing from spirit and principles of the disclosure. Such changes, alternatives, and modifications all fall into the scope of the claims and their equivalents.

What is claimed is:

1. a method of substation-control center two-level distributed modeling for power grid, comprising:
(1) building a substation model locally for each of substations, the substation model comprising a network model having a topological structure, parameters and measurement information of the substation devices, and a wiring diagram of each substation based on a whole line identification consistency;
(2) uploading each substation model to the control center through a state power dispatching data network; and
(3) splicing network models for the substations according to the wiring diagrams of the substations to build a whole power grid model of a whole power grid so as to monitor and control the whole power grid.

2. The method according to claim 1, wherein the network model comprises a three-phase topological structure, three-phase parameters, and three-phase measurement information of the substation devices, and the wiring diagram of each substation comprises graphics and three-phase dynamic data of the substation devices.

3. The method according to claim 2, wherein the step (1) comprises:
obtaining real-time measurement data of each substation according to an IEC61850 standard to monitor each substation in real time so as to monitor each substation according to the network model for each substation as well as the wiring diagram and the real-time measurement data of each substation.

4. The method according to claim 2, wherein the step (1) comprises:
clipping the network model for each substation to be adapted to the control center and clipping the wiring diagram of each substation to be adapted to the control center.

5. The method according to claim 4, wherein clipping the network model for each substation to be adapted to the control center comprises:
(a) converting the three-phase topological structure and the three-phase parameters of the substation devices into a single-phase positive-sequence topological structure and single-phase positive-sequence parameters of the substation devices respectively;
(b) replacing station load transformer and house load transformer with low voltage level by equivalent loads in the network model for each substation;
(c) converting analogue measurement information in the three-phase measurement information into positive-sequence analogue measurement information and removing analogue measurement information of a breaker in the positive-sequence analogue measurement information; and
(d) converting digital measurement information in the three-phase measurement information into total digital measurement information.

6. The method according to claim 5, wherein clipping the wiring diagram of each substation to be adapted to the control center comprises:
removing graphics of a grounding switch in the wiring diagram;
replacing graphics of the station load transformer and the house load transformer in each substation with low voltage level by graphics of the equivalent loads; and
converting the three-phase dynamic data in the wiring diagram into single-phase dynamic data.

7. The method according to claim 4, wherein the step (1) further comprises:
exporting the clipped network model for each substation.

8. The method according to claim 7, wherein exporting the clipped model for each substation comprises:
exporting the clipped network model for each substation as a network model XML file accorded with a common information model, and expanding a portion of classes in the network model XML file; and
exporting the clipped wiring diagram of each substation as a wiring diagram XML file accorded with scalable vector graphics.

9. The method according to claim 8, wherein expanding a portion of classes in the network model XML file comprises:
adding address attributes for a substation class in the network model XML file; and
adding address attributes for a measure value class in the network model XML file.

10. The method according to claim 8, before the step (2), further comprising:
judging the exported network model for each substation and the exported wiring diagram of each substation; and executing the step (2) if the network model for each substation and the wiring diagram of each substation are different from a previous network model for each substation and a previous wiring diagram of each substation or the network model for each substation or the wiring diagram of each substation is not uploaded, otherwise, returning to the step (1) after a first predetermined time (T₁).

11. The method according to claim 8, before the step (3), further comprising:
checking the network model for each substation and the wiring diagram of each substation.

12. The method according to claim 11, wherein checking the network model for each substation and the wiring diagram of each substation comprises:
parsing the network model XML file to check whether the network model XML file accords with a format of the common information model file, and to check the topological structure of each substation, and sending error information to a corresponding substation through the state power dispatching data network and returning to the step (1) if either checking is not successful;
parsing the wiring diagram XML file to check whether the wiring diagram XML file accords with a format of scalable vector graphics and to check whether mappings of the scalable vector graphics and the common information model match each other, and sending error information to a corresponding substation through the state power dispatching data network and returning to the step (1) if either checking is not successful; and
executing the step (3) if all of the checking are successful.

13. The method according to claim 12, wherein the step (3) comprises:
3-1) importing a network model for one substation to build a substation model having a hierarchical structure and a line model list of the one substation;
3-2) importing a network model for a next substation to build a substation model and a line model list of the next substation, and adding the substation model of the next substation to the built substation model of the one substation;
3-3) determining whether the line model of the next substation exists in the built line model of the one substation, deleting the line model of the next substation line model list and associating terminals and measurement information associated with the line model of the next substation with the built line model of the one substation line model list if the line model of the next substation exists in the built line model of the one substation, and directly adding the line model of the next substation model list as well as terminals and measurement information associated therewith to the built line model of the one substation model list if the line model of the next substation does not exist in the built line model of the one substation;
3-4) traversing all the line models of the next substation line model list to finish the splicing of the network model for the next substation; and
3-5) repeating the step 3-2) to the step 3-4) until all substations are traversed so as to build the whole power grid model according to a final substation model and a final line model.

14. The method according to claim 13, wherein each substation model has a hierarchical structure of a substation-voltage level-device.

15. The method according to claim 13, after the step (3), further comprising:
collecting real-time measurement data through the control center to obtain measurement information.

16. The method according to claim 13, wherein the control center obtains messages of station addresses, information object addresses and real-time data values through an IEC61850-104 protocol, and the real-time data values are values of a measure value object when information object addresses of the measure value object and station addresses of a substation comprising the measure value object in the measurement information are accorded with those in the messages respectively.

17. The method according to claim 15, further comprising:
determining whether a network model for the control center is false, sending a command of calling the substation model for each substation and the wiring diagram of each substation and returning to the step (2) if the network model for the control center is false, and determining whether the network model for the control center is false again after a second predetermined time (T₂) if the network model for the control center is not false; and
sending a command of calling the substation model for each substation and the wiring diagram of each substation through other servers in the state power dispatching data network and returning to the step (2) if the control center is paralyzed.

18. The method according to claim 15, wherein it is determined that the network model for the control center is false when a topological structure of the control center is false, state estimation computing based on the network model for the control center is not convergent, and a database of the control center is false.
